(19) United States
(12) Patent Application Publication
(10) Pub. No.: US 2026/0036253 A1
(43) Pub. Date: Feb. 5, 2026

(54) Sliding Hook System and Method of Manufacture

(71) Applicant: Brian Douglas Moran, Rancho Santa Margarita, CA (US)

(72) Inventor: Brian Douglas Moran, Rancho Santa Margarita, CA (US)

(21) Appl. No.: 18/791,648

(22) Filed: Aug. 1, 2024

(51) Int. Cl. F16M 13/02; B62H 3/12

(52) U.S. Cl. CPC F16M 13/022; B62H 3/12; F16M 13/027

(57) ABSTRACT

The invention relates to a sliding hook system for hanging objects, comprising a plastic body formed via injection molding, at least one metallic insert integrally molded into the body, a hook member embedded within the body, and at least one bearing positioned on a smooth surface of the metallic insert. The invention also encompasses a method of manufacturing the sliding hook system, which includes providing a mold, positioning a metallic insert and a hook member within the mold, injecting molten material to form the body, allowing the material to cool and solidify, and placing at least one bearing onto the smooth surface of the metallic insert. This method ensures secure integration of components, enhancing the strength, stability, and cost-effectiveness of the sliding hook system.

### FIELD OF INVENTION

The present invention relates generally to the field of storage systems, specifically to a sliding hook system for hanging objects and the method of manufacturing such a system. This invention is particularly useful for organizing and storing bicycles and other items in a space-efficient manner.

### BACKGROUND

In the field of bicycle storage, various mechanisms have been developed to provide secure and efficient solutions for hanging and organizing bikes. Traditional systems often rely on hooks and mounts that are either completely metallic or entirely plastic. These existing designs, while functional, come with significant drawbacks that necessitate improvements.

Metallic hooks and storage systems, although robust and durable, are generally costly to produce and heavy. The high cost of raw materials, along with complex manufacturing processes, contributes to increased production expenses. Additionally, the weight of these systems makes them cumbersome and less practical for users, especially when frequent adjustments or relocations are needed. On the other hand, all-plastic systems are lighter and more cost-effective, yet they often suffer from issues related to material strength and durability. Plastic hooks and mounts can warp, shrink, or even break under the load of a bicycle, particularly over time. These systems are prone to significant deformation during the cooling process post-manufacture, which compromises their structural integrity and reliability.

A critical challenge in current designs is the difficulty in achieving a balance between cost, durability, and ease of manufacture. Plastic hooks, while cheaper and easier to produce, lack the necessary strength and dimensional stability, leading to potential failure under load. Metallic hooks, though strong, are not economically viable for mass production due to their higher material and manufacturing costs. Another limitation in existing systems is the assembly complexity. Many designs require multiple components and additional assembly steps, increasing labor costs and time. This complexity not only affects the manufacturing process but also impacts the end-user experience, as installation and adjustments become more cumbersome.

Moreover, existing bicycle hook systems often lack versatility and adaptability, which are increasingly important to consumers. Many current designs are fixed and do not allow for customization based on the user's specific storage needs or spatial constraints. For instance, homeowners with limited space may require adjustable systems that can be tailored to fit into closets, garages, or other confined areas. Fixed systems do not offer this flexibility, limiting their usability and appeal. Aesthetic considerations are also often overlooked in traditional bike storage solutions. Consumers today seek products that not only perform well but also integrate seamlessly into their home environments. Metallic systems, while functional, often present a rough, industrial appearance that may not be desirable for residential settings. Plastic systems, conversely, may offer a cleaner look but fail to deliver on performance and durability.

The advent of advanced materials and manufacturing techniques has opened new avenues for innovation in this domain. Injection molding, for instance, offers a way to integrate multiple functionalities into a single manufacturing step, potentially reducing production complexity and cost. However, leveraging these techniques effectively requires careful consideration of material properties and design intricacies to overcome the inherent limitations of existing systems. Ultimately, the need for a robust, cost-effective, and aesthetically pleasing bicycle storage solution has driven the development of this new invention. By addressing the shortcomings of current designs—such as material costs, durability, complexity, and lack of adaptability—this invention aims to offer a superior alternative that meets the evolving demands of consumers.

It is within this context that the present invention is provided.

### SUMMARY

The present invention relates to a sliding hook system for hanging objects and a method of manufacturing such a system. The sliding hook system comprises a body formed through an injection molding process, at least one metallic insert integrally molded into the body, a hook member embedded within the body, and at least one bearing positioned on the smooth surface of the metallic insert. This configuration provides a durable, cost-effective, and versatile solution for hanging objects, overcoming the limitations of purely metallic or plastic systems.

The method of manufacturing the sliding hook system involves providing a mold, positioning at least one metallic insert and a hook member within the mold, injecting molten material to form the body, allowing the material to cool and solidify, and placing at least one bearing onto the smooth surface of the metallic insert. This method ensures a secure integration of the components, enhancing the strength and stability of the hook system while reducing manufacturing complexity and costs.

In some embodiments, the body is made from a polymer material, which can include nylon with 33% glass-filled fiber. This provides sufficient strength and durability for light-duty applications while being cost-effective.

In further embodiments, the textured surface of the metallic insert comprises knurling, which improves adhesion between the insert and the body, ensuring a secure and stable connection.

In yet further embodiments, the hook member comprises raised features such as threads or splines. These features enhance the securement of the hook member within the body, preventing it from loosening or detaching during use.

In additional embodiments, a plurality of bearings can be positioned on the smooth surface of the metallic insert. This configuration facilitates smooth sliding motion and distributes the load evenly, reducing wear and tear.

In other embodiments, the metallic insert can be made from materials such as aluminum, steel, or brass. These materials offer varying degrees of strength and corrosion resistance, allowing customization based on specific application requirements.

In some embodiments, the body includes a recess for receiving a sticker or company logo. This feature allows for branding and aesthetic customization without compromising the functionality of the hook system.

In further embodiments, the hook member is interchangeable with various end effects, including hooks of different sizes and shapes. This adaptability allows the system to be tailored to different objects and storage needs.

In yet further embodiments, a locking mechanism can be included to fix the position of the hook member relative to the body. This mechanism can comprise a threaded insert embedded into the body and a corresponding threaded portion on the hook member, providing secure positioning.

In additional embodiments, a lock nut can be used to secure the hook member in place, offering additional stability and preventing unintended movement.

In other embodiments, the system can include a wave washer or spring washer to provide controlled friction between the hook member and the body. This feature ensures smooth operation and prevents excessive wear.

In some embodiments, the body is adapted to include embossments or other decorative features formed during the injection molding process, allowing for aesthetic customization.

In further embodiments, the body can be configured to mount to a rail or strut channel system for adjustable positioning, enhancing the versatility and usability of the system in various storage environments.

In yet further embodiments, the body includes multiple cavities to accommodate a multiplicity of metallic inserts and hook members, allowing for more complex and functional designs.

In additional embodiments, the system can comprise means for ceiling or wall mounting, including brackets or mounting hardware integrally formed with or attached to the body, providing various installation options.

In other embodiments, the metallic insert includes a flange or other feature to prevent axial movement within the body during use, enhancing the stability and reliability of the hook system.

In some embodiments, the hook member can have a protective coating to prevent damage to hanging objects, ensuring that the system is suitable for delicate items.

In further embodiments, the body can be formed with a specific geometric shape to enhance strength and load distribution, providing a robust solution for hanging objects.

### BRIEF DESCRIPTION OF THE DRAWINGS

Various embodiments of the invention are disclosed in the following detailed description and accompanying drawings.

FIG. 1A illustrates an example perspective view of the sliding hook system.

FIG. 1B illustrates an example exploded view of the sliding hook system showing its components.

FIG. 1C illustrates an example front view of the sliding hook system.

FIG. 1D illustrates an example cross-sectional view of the sliding hook system.

FIG. 2A illustrates an example of three bicycles hanging from separate hooks mounted on a rail.

FIG. 2B illustrates an example of one bicycle slid to the left to be closer to the others on the rail, freeing up space.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” indicate an acceptable degree of error or variation in measurements, usually within 20%, preferably within 10%, and more preferably within 5% of a given value or range. Numerical values provided in this description are approximate unless stated otherwise.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “body” refers to the main structural component of the sliding hook system formed via injection molding. This includes, but is not limited to, polymer materials such as nylon, which may be reinforced with glass-filled fibers to enhance strength and durability. In one example implementation, the body is molded from nylon with 33% glass-filled fiber to provide a lightweight yet robust structure suitable for supporting hanging objects.

The term “metallic insert” refers to a metal component that is integrally molded within the body during the injection molding process. This includes, but is not limited to, metals such as aluminum, steel, and brass. The metallic insert features a textured surface to improve adhesion with the body and a smooth surface for accommodating a bearing. In one example implementation, the metallic insert is made of aluminum, with knurling on the textured surface to enhance bonding with the polymer body and a precision ground smooth surface to facilitate the placement of a bearing.

The term “hook member” refers to the component embedded within the body designed to hang objects. This includes, but is not limited to, various shapes and sizes of hooks or other end effects. The hook member has raised features such as threads or splines to secure it within the body during the molding process. In one example implementation, the hook member is a standard S-shaped hook with threaded features that allow the molten polymer to shrink around it, creating a tight and secure fit.

The term “bearing” refers to a mechanical component that facilitates the sliding motion of the hook system along a track or rail. This includes, but is not limited to, roller bearings, ball bearings, or other suitable types of bearings that can be positioned on the smooth surface of the metallic insert. In one example implementation, the bearing is a roller bearing placed on the ground surface of the aluminum insert, enabling smooth and efficient movement of the hook along a strut channel.

The term “textured surface” refers to the part of the metallic insert designed to enhance its adhesion to the molded body. This includes, but is not limited to, surfaces treated with knurling, splines, or other surface treatments that increase the surface area and mechanical interlocking with the polymer. In one example implementation, the textured surface is achieved through knurling, which creates small ridges and grooves on the surface of the aluminum insert, thereby improving the bonding with the surrounding polymer material.

The term “smooth surface” refers to the part of the metallic insert designed to interface with the bearing, providing a low-friction area for movement. This includes, but is not limited to, surfaces that have been ground or polished to a fine finish. In one example implementation, the smooth surface is a precision-ground section of the aluminum insert, allowing for the seamless placement and rotation of a roller bearing.

In one example implementation, the sliding hook system can be used in a rail or strut channel system to provide adjustable positioning for hanging objects. The body can be designed with specific geometric shapes to enhance strength and load distribution, and may include features such as recesses for branding or decorative elements. The hook member can be interchangeable, allowing for various end effects to be used with the same body, enhancing the versatility and adaptability of the system for different storage needs.

The method of manufacturing the sliding hook system includes the steps of positioning the metallic insert and hook member within a mold, injecting molten polymer material to form the body, allowing the material to cool and solidify, and placing the bearing onto the smooth surface of the metallic insert. This process ensures that the components are securely integrated into the body, providing a strong, durable, and cost-effective solution for hanging and organizing objects.

### DESCRIPTION OF DRAWINGS

The present invention relates to a sliding hook system for hanging objects and a method of manufacturing such a system. The invention addresses several shortcomings associated with prior art, such as high production costs, structural instability, and lack of versatility. Traditional systems either rely on purely metallic hooks, which are costly and heavy, or entirely plastic hooks, which suffer from issues of warping, shrinking, and lack of durability. This invention combines the strengths of both materials to create a robust, cost-effective, and adaptable solution.

The sliding hook system includes a body formed via an injection molding process, at least one metallic insert integrally molded within the body, a hook member embedded within the body, and at least one bearing positioned on a smooth surface of the metallic insert. This configuration not only provides the necessary structural strength and stability but also ensures that the manufacturing process remains cost-effective and efficient. The combination of a metallic insert with a polymer body overcomes the limitations of shrinkage and warping seen in all-plastic designs, while also reducing the weight and cost compared to all-metal systems.

One of the primary benefits of this invention is its versatility. The hook member can be easily interchanged with various end effects, allowing for customization based on the user's specific storage needs. Additionally, the body can be adapted to include decorative features or branding, making it suitable for residential environments where aesthetics are important. The sliding mechanism, facilitated by the bearing on the metallic insert, allows for smooth and easy adjustment along a rail or strut channel system, further enhancing the utility and adaptability of the product.

The method of manufacturing the sliding hook system involves providing a mold, positioning the metallic insert and hook member within the mold, injecting molten material to form the body, allowing the material to cool and solidify, and placing the bearing onto the smooth surface of the metallic insert. This method ensures that the components are securely integrated into the body, enhancing the overall strength and durability of the system while simplifying the manufacturing process and reducing costs.

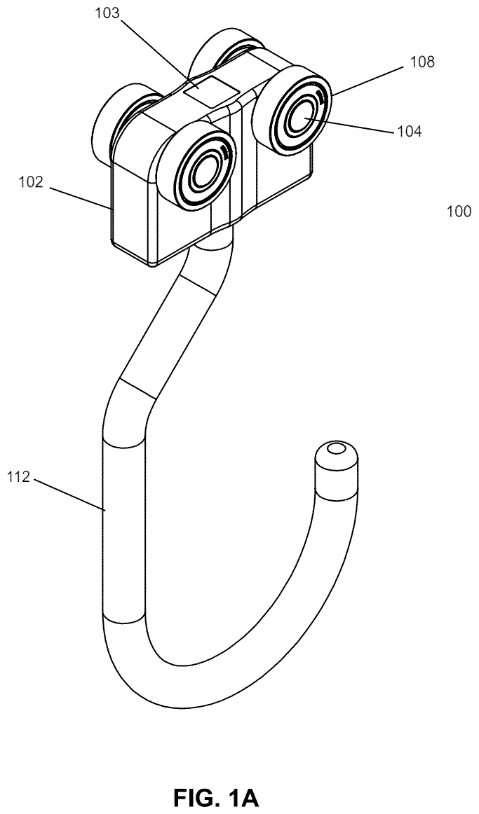

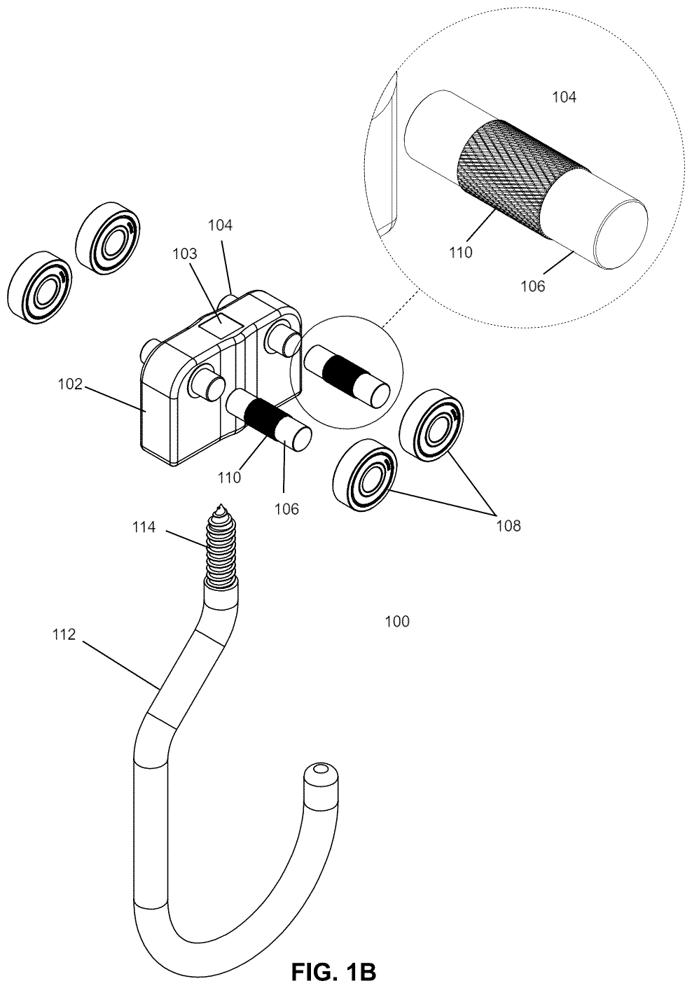

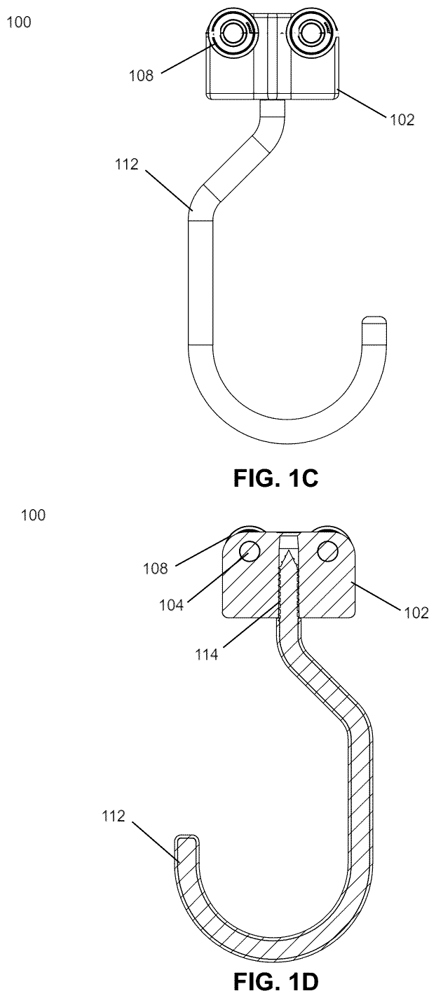

Referring now to the drawings, FIG. 1A and FIG. 1B, a perspective view of the sliding hook system 100 and an exploded view of the sliding hook system 100, illustrating the individual components and their assembly are shown.

The system includes a plastic body 102 formed via an injection molding process. The body 102 houses two metallic inserts 104, each of which is positioned horizontally through the body 102. The metallic inserts 104 feature a smooth surface 106 for accommodating roller bearings 108 and a textured surface 110 for enhancing adhesion within the plastic body 102. The roller bearings 108 are positioned around the smooth surfaces 106 of the metallic inserts 104, facilitating the sliding motion of the hook system 100 along a rail or strut channel (not shown). Extending downward from the body 102 is a hook member 112, intended for hanging objects such as bicycles. The hook member 112 is embedded within the body 102 during the molding process and is secured by raised features 114, such as threads or splines, which interact with the body 102 to prevent loosening or detachment during use. A recess 103 for receiving a sticker or company logo is also shown at the top of the body.

The plastic body 102 is shown with two metallic inserts 104 partially inserted, revealing the textured surfaces 110, which include knurling to enhance bonding with the plastic material of the body 102. The smooth surfaces 106 of the metallic inserts 104 are designed to accommodate the roller bearings 108, which are shown removed from their positions. The roller bearings 108, when assembled, enable the smooth sliding motion of the hook system 100. The hook member 112 is depicted separate from the body 102, with its threaded end 114 designed for secure attachment within the body 102 during the injection molding process. This configuration ensures that the hook member 112 is tightly integrated with the body 102, providing a robust and stable structure for hanging objects.

FIG. 1C depicts a front view of the sliding hook system 100. The system includes a plastic body 102, which houses two metallic inserts 104 positioned horizontally through the body 102. Each metallic insert 104 features a smooth surface 106 on which roller bearings 108 are mounted. The roller bearings 108 facilitate the sliding motion of the hook system 100 along a rail or strut channel (not shown). Extending downward from the body 102 is the hook member 112, designed to hang objects such as bicycles. The hook member 112 is shown centrally aligned and integrated within the body 102.

FIG. 1D provides a cross-sectional view of the sliding hook system 100 taken along the line indicated in FIG. 1C. This sectional view reveals the internal structure and secure integration of the components. The plastic body 102 is shown with the metallic inserts 104 embedded within it. The textured surface 110 of the metallic insert 104, which includes knurling, can be seen enhancing the adhesion between the insert 104 and the plastic material of the body 102. The hook member 112 is embedded within the body 102, secured by its raised features 114, such as threads or splines, which ensure a tight fit and prevent detachment. This cross-sectional view highlights the robust construction and effective integration of the metallic inserts 104 and hook member 112 within the plastic body 102, providing a clear understanding of the assembly and structural integrity of the sliding hook system 100.

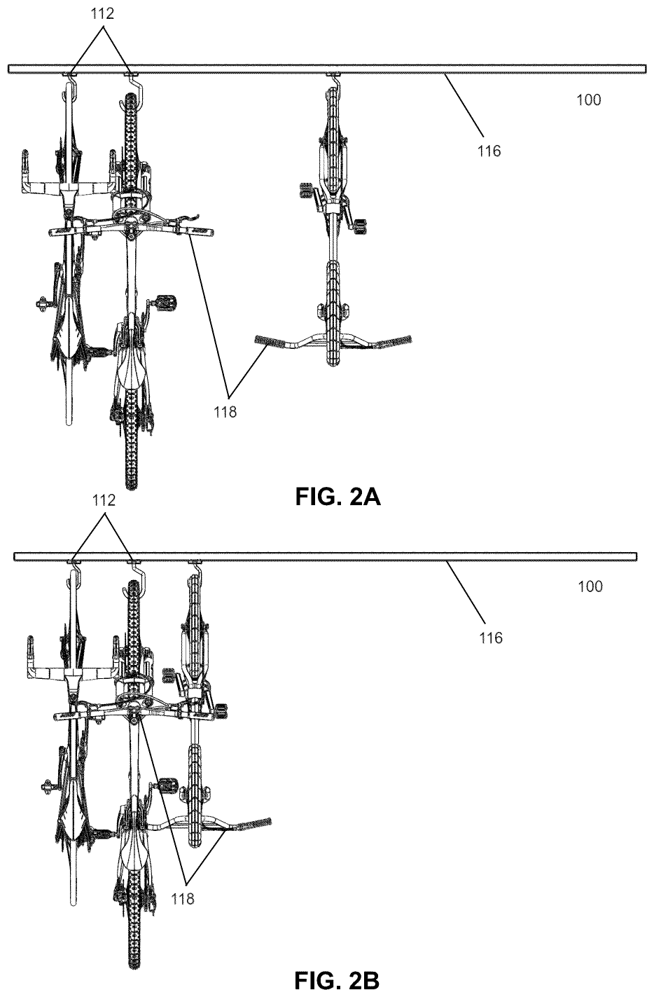

FIG. 2A illustrates a system for hanging bicycles using the sliding hook system 100 mounted on a rail 116. Three bicycles 118 are shown hanging from separate hooks 112 of the invention. The hooks 112 are attached to the plastic bodies 102, which are slidably mounted on the rail 116. The rail 116 provides a support structure that allows the hooks 112 to move horizontally, facilitating the efficient organization and storage of the bicycles 118. Each hook 112 is securely integrated with its corresponding plastic body 102, which houses the metallic inserts 104 and roller bearings 108, enabling smooth sliding motion along the rail 116.

FIG. 2B depicts the same system, with one of the bicycles 118 slid to the left to be closer to the others, thereby freeing up space on the right side of the rail 116. This figure demonstrates the functionality and advantage of the sliding hook system 100, showcasing its ability to adapt to different storage needs and spatial constraints. The smooth sliding mechanism, facilitated by the roller bearings 108 on the metallic inserts 104 within the plastic bodies 102, allows for easy repositioning of the bicycles 118 along the rail 116. This adaptability enhances the usability of the storage system, making it convenient for users to organize and access their bicycles 118 efficiently.

In some embodiments, the method of manufacturing the sliding hook system involves several steps designed to ensure the integration of metallic and plastic components in a robust and cost-effective manner. Initially, a mold is prepared to shape the body of the hook system. The mold is configured to receive the metallic inserts and the hook member, which are key components of the system.

The process begins by positioning at least one metallic insert within the mold. The metallic insert includes a textured surface, such as knurling or splines, to improve adhesion with the plastic material, and a smooth surface to accommodate a bearing. The hook member, which includes raised features like threads or splines, is also placed within the mold. These raised features ensure that the hook member is securely embedded within the plastic body during the molding process.

Once the metallic insert and hook member are correctly positioned, molten plastic material is injected into the mold. The plastic material surrounds the metallic insert and hook member, forming the body of the sliding hook system. The chosen plastic material is typically a polymer such as nylon reinforced with glass fibers to provide the necessary strength and durability for the application. As the molten plastic cools and solidifies, it shrinks around the raised features of the hook member, securing it firmly within the body. This shrinkage also enhances the bonding between the metallic insert's textured surface and the plastic body.

After the plastic has fully cooled and solidified, the molded body, now integrated with the metallic insert and hook member, is removed from the mold. The pre-molded thread pattern in the body is set by the hooks, ensuring precise alignment and fit. The bodies are then quickly moved to a work area using a motorized table, where the hooks are set in place and allowed to cool further. This controlled cooling process ensures that the plastic shrinks tightly around the hook, creating a secure and robust connection.

Subsequently, roller bearings are placed onto the smooth surfaces of the metallic inserts. These bearings facilitate the sliding motion of the hook system along a rail or strut channel, providing smooth and efficient movement. The integration of the bearings onto the metallic inserts ensures that the sliding hook system can support the load of hanging objects, such as bicycles, while maintaining ease of adjustability along the rail.

The method of manufacture also allows for additional customization and adaptability of the system. For example, the mold can be configured to include recesses or pockets for branding or decorative elements. Moreover, different end effects, such as hooks or eyes of various sizes and shapes, can be embedded within the same body configuration, providing versatility in the system's application.

This manufacturing process leverages the advantages of both metallic and plastic materials, ensuring a strong, durable, and cost-effective sliding hook system. The integration of the metallic insert within the plastic body addresses issues of warping and shrinking associated with fully plastic designs, while also reducing the weight and cost compared to fully metallic systems. The result is a highly functional and adaptable storage solution suitable for a wide range of applications. The few-step process, including setting the pegs into the mold, moving the bodies with a motorized table, and allowing controlled cooling, ensures efficiency and precision in the production of the sliding hook system.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the sliding hook system and method of manufacture of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A sliding hook system for hanging objects, comprising:
a plastic body formed through an injection molding process;
at least one metallic insert integrally molded into the body, the metallic insert comprising:
a textured surface to improve adhesion with the body, and
a smooth surface for accommodating a bearing;
a hook member embedded within the body during the molding process;
at least one bearing positioned on the smooth surface of the metallic insert.

2. The sliding hook system of claim 1, wherein the body is made from a polymer material.

3. The sliding hook system of claim 2, wherein the polymer material is nylon with 33% glass-filled fiber.

4. The sliding hook system of claim 1, wherein the textured surface of the metallic insert comprises knurling.

5. The sliding hook system of claim 1, wherein the hook member comprises raised features selected from the group consisting of threads and splines to enhance its securement within the body.

6. The sliding hook system of claim 1, further comprising a plurality of bearings positioned on the smooth surface of the metallic insert.

7. The sliding hook system of claim 1, wherein the metallic insert is made from a material selected from the group consisting of aluminum, steel, and brass.

8. The sliding hook system of claim 1, wherein the body includes a recess for receiving a sticker or company logo.

9. The sliding hook system of claim 1, wherein the hook member is interchangeable with various end effects, including hooks of different sizes and shapes.

10. The sliding hook system of claim 1, further comprising a locking mechanism to fix the position of the hook member relative to the body.

11. The sliding hook system of claim 10, wherein the locking mechanism comprises a threaded insert embedded into the body and a corresponding threaded portion on the hook member.

12. The sliding hook system of claim 11, further comprising a lock nut to secure the hook member in place.

13. The sliding hook system of claim 1, further comprising a wave washer or spring washer to provide controlled friction between the hook member and the body.

14. The sliding hook system of claim 1, wherein the body is adapted to include embossments or other decorative features formed during the injection molding process.

15. The sliding hook system of claim 1, wherein the body is configured to mount to a rail or strut channel system for adjustable positioning.

16. The sliding hook system of claim 1, wherein the body includes multiple cavities to accommodate a multiplicity of metallic inserts and hook members.

17. The sliding hook system of claim 1, further comprising a means for ceiling or wall mounting, including brackets or mounting hardware integrally formed with or attached to the body.

18. The sliding hook system of claim 1, wherein the metallic insert includes a flange or other feature to prevent axial movement within the body during use.

19. The sliding hook system of claim 1, further comprising a protective coating on the hook member to prevent damage to hanging objects.

20. A method of manufacturing a sliding hook system for hanging objects, comprising the steps of:
providing a mold configured to form a body;
positioning at least one metallic insert within the mold, the metallic insert comprising a textured surface and a smooth surface;
inserting a hook member into the mold, the hook member having raised features;
injecting molten plastic material into the mold to form the body, the molten material surrounding the metallic insert and the hook member, thereby integrating them into the body;
allowing the molten material to cool and solidify to form the body with the metallic insert and hook member securely embedded;
removing the formed sliding hook system from the mold;
placing at least one bearing onto the smooth surface of the metallic insert.
